(19) United States
(12) Patent Application Publication
(10) Pub. No.: US 2025/0128369 A1
(43) Pub. Date: Apr. 24, 2025

(54) MOBILE CNC SYSTEM

(71) Applicant: Martino Family Holdings, Key Largo, FL (US)

(72) Inventor: Michael Martino, Davie, FL (US)

(21) Appl. No.: 18/382,133

(22) Filed: Oct. 20, 2023

(51) Int. Cl. B23Q 1/01; B23Q 11/00

(52) U.S. Cl. CPC B23Q 1/015; B23Q 11/0046

(57) ABSTRACT

A mobile computer numerical control (CNC) system may include a motor vehicle that includes a first container defining an enclosed compartment; a CNC machine mounted on the motor vehicle and positioned inside the enclosed compartment; a battery that is constructed and arranged to provide power to at least the CNC machine; and a power inverter that is in electrical communication with the battery and the CNC machine, wherein the power inverter is constructed and arranged to convert a direct current (DC) from the battery to an alternating current (AC), and wherein the power inverter is further constructed and arranged to provide at least the CNC machine with the AC current.

### TECHNICAL FIELD

The embodiments generally relate to the field of computer numerical control (CNC) systems.

### BACKGROUND

CNC machines are commonly heavy and difficult to move or transport to job sites in operational condition.

Some CNC machines are mobile, but these CNC machines are generally not protected from weather or sunlight.

### SUMMARY

This summary is provided to introduce a variety of concepts in a simplified form that is further disclosed in the detailed description of the embodiments. This summary is not intended to identify key or essential inventive concepts of the claimed subject matter, nor is it intended for determining the scope of the claimed subject matter.

In general, the disclosed mobile computer numerical control (CNC) system may include a motor vehicle that includes a first container defining an enclosed compartment; a CNC machine mounted on the motor vehicle and positioned inside the enclosed compartment; a battery that is constructed and arranged to provide power to at least the CNC machine; and a power inverter that is in electrical communication with the battery and the CNC machine, wherein the power inverter is constructed and arranged to convert a direct current (DC) from the battery to an alternating current (AC), and wherein the power inverter is further constructed and arranged to provide at least the CNC machine with the AC current.

Other illustrative variations within the scope of the invention will become apparent from the detailed description provided hereinafter. The detailed description and enumerated variations, while disclosing optional variations, are intended for purposes of illustration only and are not intended to limit the scope of the invention.

### BRIEF DESCRIPTION OF THE DRAWINGS

A more complete understanding of the embodiments, and the attendant advantages and features thereof, will be more readily understood by references to the following detailed description when considered in conjunction with the accompanying drawings wherein:

FIG. 1 illustrates an illustrative depiction of a CNC machine of a mobile CNC system as disclosed herein;

FIG. 2 illustrates an illustrative depiction of a CNC machine, a battery, and a power inverter of a mobile CNC system as disclosed herein;

FIG. 3 illustrates an illustrative depiction of an engine compartment of a motor vehicle of a mobile CNC system as disclosed herein;

FIG. 4 illustrates an illustrative depiction of a motor vehicle of a mobile CNC system as disclosed herein; and

FIG. 5 illustrates an illustrative depiction of mechanical isolator mounted between a CNC machine and a motor vehicle as disclosed herein.

The drawings are not necessarily to scale, and certain features and certain views of the drawings may be shown exaggerated in scale or in schematic in the interest of clarity and conciseness.

### DETAILED DESCRIPTION

The specific details of the single embodiment or variety of embodiments described herein are to the described product or methods of use. Any specific details of the embodiments are used for demonstration purposes only and no unnecessary limitations or inferences are to be understood from there.

It is noted that the embodiments reside primarily in combinations of components and procedures related to the products. Accordingly, the product and components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

In general, the embodiments described herein relate to a CNC system that comprises a CNC machine. In some embodiments, the CNC system can comprise a motor vehicle that includes a first container defining an enclosed compartment. In some embodiments, the CNC machine can be mounted on the motor vehicle and positioned inside the enclosed compartment so that the CNC machine is protected from weather and sunlight. As the CNC machine is mounted on the motor vehicle, the CNC machine is mobile and can be transported to different locations while remaining in operational condition.

The CNC machine can include a CNC router. The CNC router can cut, drill, mill, carve, engrave, and shape any suitable materials such as, for example, wood, plastics, elastomers, thermoplastic elastomers, foams, metals, or any combination thereof.

In some embodiments, the CNC router can have a width of approximately 4 to 5 feet and a length of approximately 8 feet.

In some embodiments, the motor vehicle can be a straight truck or a semi-truck. The straight truck can be a box truck.

The CNC system can include a battery that is constructed and arranged to provide power at least to the CNC machine and to any electronics in the motor vehicle. A power inverter can convert a direct current (DC) from the battery to an alternating current (AC) that is provided at least to the CNC machine.

The battery can power the CNC machine while the CNC machine is mounted on the motor vehicle. The CNC machine can be powered and operational while the motor vehicle transports the CNC machine, or while the motor vehicle is stationary.

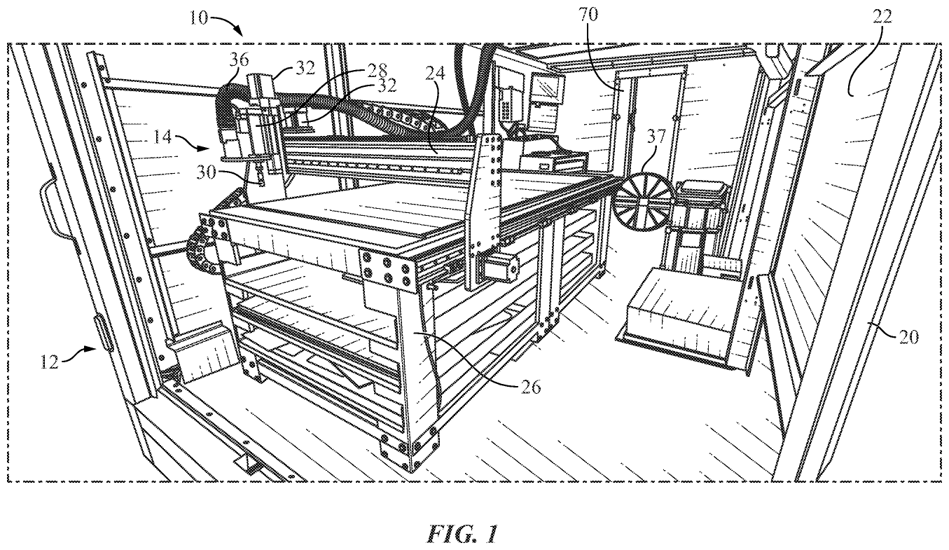

FIG. 1 shows a CNC system 10, according to some embodiments disclosed herein. The CNC system 10 can comprise a motor vehicle 12 that includes a first container 20 that defines a compartment 22. The CNC system 10 can comprise a CNC machine 14 mounted on the motor vehicle 12 and positioned inside the compartment 22. In some embodiments, the CNC machine 14 can be a CNC router 14. An air flow source 37 can be constructed and arranged to direct an air flow toward at least the CNC machine 14.

The CNC machine 14 can include a gantry 24 mounted on a worktable 26. The gantry 24 can be constructed and arranged to support and guide the movement of at least a CNC tool 30 attached to a spindle motor 28. In some embodiments, the CNC tool 30 can include any suitable CNC tool 30, such as, for example, a router bit. One or more actuators 32 can be constructed and arranged to control the movement of at least the CNC tool 30 and the spindle motor 28. The one or more actuators 32 can include one or more servo motors, one or more stepper motors, or any combination thereof.

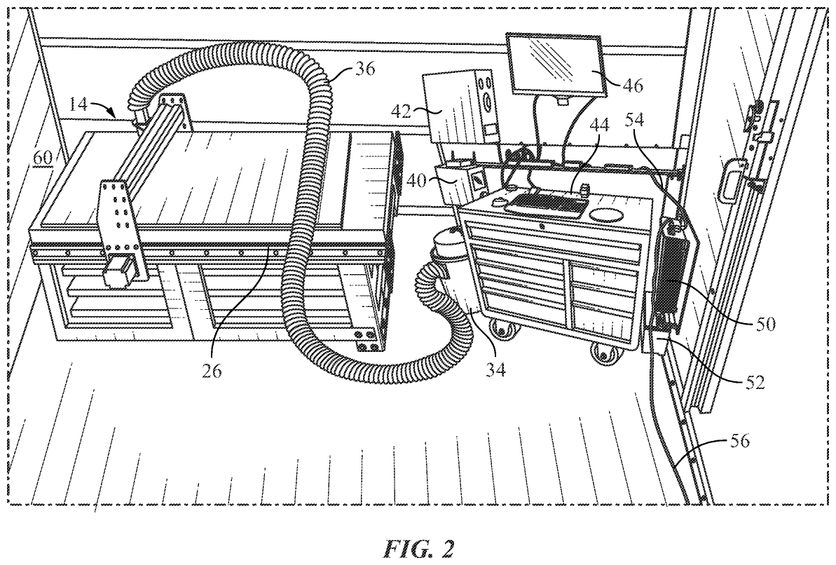

Referring to FIG. 2, the CNC machine 14 can include a computer 40 and a motion controller 42 (e.g., a control box), wherein the computer 40 is in electrical communication with the motion controller 42 to control the movement of the CNC tool 30. The computer 40 can interpret instructions stored in any suitable programming language, such as, for example, geometric code (G-code), which defines the movement and operation of the CNC tool 30. The computer 40 sends commands to the motion controller 42 based on the instructions. The motion controller 42 translates the commands into electrical signals which can be amplified by an amplifier that is integrated with the motion controller 42 or otherwise in electrical communication with the motion controller 42. The motion controller 42 can be in electrical communication with the one or more actuators 32 to send the electrical signals to the one or more actuators 32 and control the movement of at least the CNC tool 30.

The computer 40 can be connected to other devices, either wired or wirelessly, including input peripherals such as one or more keyboards 44, microphones (not shown), cameras (not shown), and/or the like. The computer 40 can, automatically and/or manually via user input through a display 46 and/or input peripherals, request, obtain, get, post, put, create, read, update, and/or delete any instructions used to control the CNC machine 14.

The CNC machine 14 can machine any suitable material based on the instructions stored on the computer 40. In some embodiments, the machined material can be installed into vehicles such as, for example, boats, automobiles, utility task vehicles, golf carts, watercrafts, and yachts. The machined material can be installed into any other suitable products.

A dust collector 34 comprising a dust collecting hose 36 can be constructed and arranged to remove dust and debris from the CNC machine 14 (e.g., the worktable 26). An inlet of the dust collecting hose 36 can be attached directly or indirectly to the spindle motor 28. The dust collector 34 can be mounted on the motor vehicle 12 and positioned inside the compartment 22.

A first battery 52 is constructed and arranged to provide power to at least the CNC machine 14, including the computer 40 and the motion controller 42. In some embodiments, the first battery 52 can be constructed and arranged to provide power to any electronics inside the motor vehicle 12, including the dust collector 34 and the air flow source 37. In some embodiments, a power inverter 50 can be in electrical communication with the first battery 52 and the CNC machine 14, wherein the power inverter 50 is constructed and arranged to convert a direct current (DC) from the first battery 52 to an alternating current (AC). The power inverter 50 is constructed and arranged to provide at least the CNC machine 14 with the AC current. The power inverter 50 can be in electrical communication with the CNC machine 14 using, for example, electrical connections 54. The first battery 52 and the power inverter 50 can be mounted on the motor vehicle 12 and positioned inside the compartment 22.

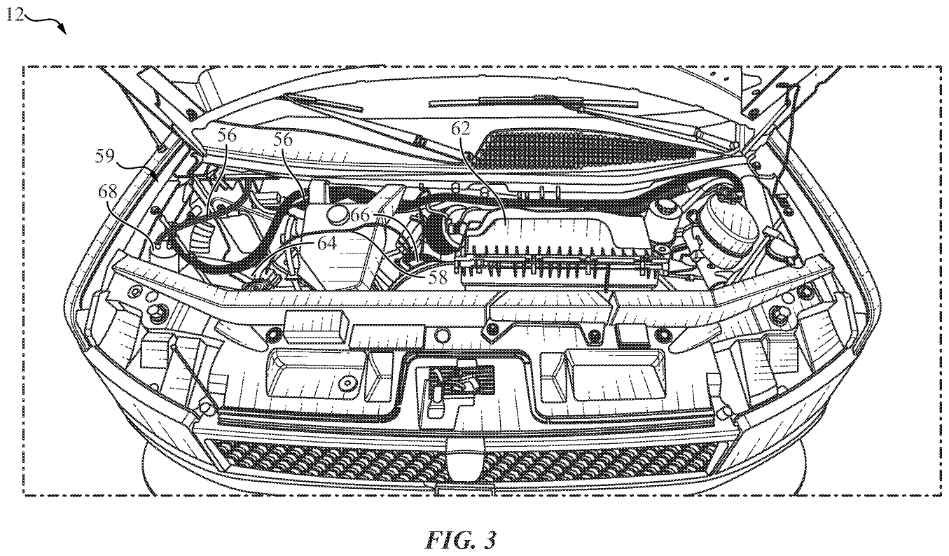

Referring to FIG. 3, the motor vehicle 12 can include an engine compartment 59 that contains an engine 62, an alternator 66, a second battery 64, and an electrical isolator 68. The alternator 66 is in mechanical communication with the engine 62, and in electrical communication with the first battery 52. The alternator 66 is constructed and arranged to charge the first battery 52. The second battery 64 can be constructed and arranged to power at least any electronics inside the motor vehicle 12. In some embodiments, the alternator 66 can be in electrical communication with the second battery 64 and can be constructed and arranged to charge the second battery 64.

In some embodiments, the second battery 64 is not constructed and arranged to power the CNC machine 14. The electrical isolator 68 can be constructed and arranged to electrically isolate the CNC machine 14, the power inverter 50, and the first battery 52 from the second battery 64 and the alternator 66. Electrical connections 56 can be made between the first battery 52, the electrical isolator 68, and the alternator 66. Electrical connections 58 can be made between the second battery 64 and the alternator 66.

Referring to FIG. 2, the first container 20 can include a door 60 that is constructed and arranged to seal (e.g., fluidly seal) the compartment 22 to form an enclosed compartment 22. When the door 60 is in a closed position, the first container 20 can completely surround the CNC machine 14. The door 60 can include any suitable seals to seal the compartment 22, such as, for example, weather stripping, compression seals, brush seals, threshold seals, etc., or any combination thereof, positioned along edges of the door 60.

Referring to FIG. 1, the first container 20 can include a second door 70 opposite the door 60, wherein the second door 70 is constructed and arranged to close an opening in the compartment 22 to form the enclosed compartment 22. When the second door 70 is in a closed position, the first container 20 can completely surround the CNC machine 14. In some embodiments, the second door 70 can seal (e.g., fluidly seal) the compartment 22 to form the enclosed compartment 22. When the second door 70 is open, a cabin of the motor vehicle is accessible from the compartment 22.

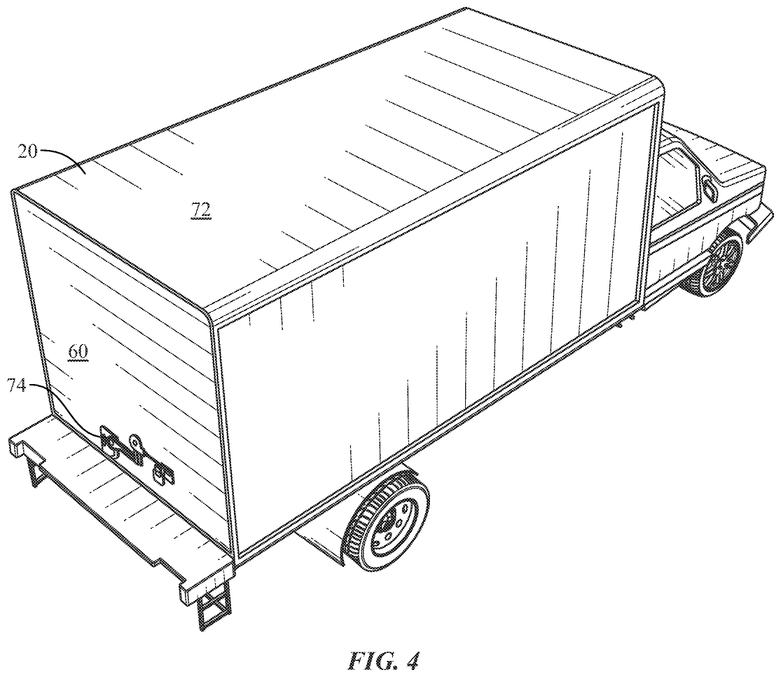

Referring to FIG. 4, in some embodiments, the motor vehicle 12 can be a box truck. The door 60 can include a latching mechanism 74 that is constructed and arranged to lock the door 60 in the closed position. The first container 20 can include a roof 72 positioned over the CNC machine 14. The roof 72 can be constructed and arranged to protect the CNC machine 14 from weather (including e.g., rain and snow), sunlight (including e.g., ultraviolet light), wind, or any combination thereof.

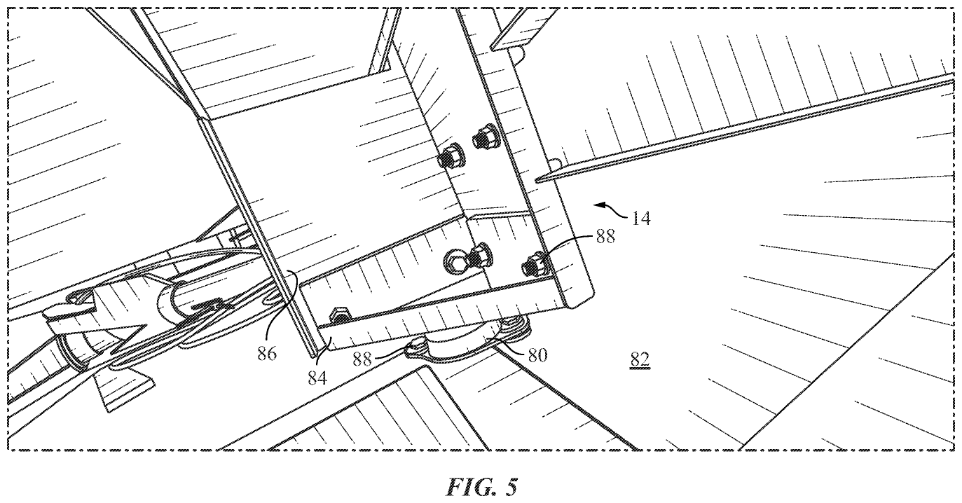

Referring to FIG. 5, mechanical isolators 80 can be mounted on the motor vehicle 12 and positioned between the CNC machine 14 and the motor vehicle 12. In some embodiments, the mechanical isolators 80 can be constructed and arranged to prevent vibrations from being transferred to the CNC machine 14 from the motor vehicle 12. In some embodiments, the mechanical isolators 80 can be constructed and arranged to dampen vibrations transferred to the CNC machine 14 from the motor vehicle 12. In some embodiments, the mechanical isolators 80 can be vibration isolators. In some embodiments, the mechanical isolators 80 can be made primarily of one or more elastomers. For example, the mechanical isolators 80 can be made primarily of rubber. Each leg 86 of the worktable 26 of the CNC machine 14 can be fastened to a respective mechanical isolator 80 by a corresponding bracket 84 and fasteners 88. Each mechanical isolator 80 can be mounted on the floor 82 of the first container 20 by fasteners 88. Fasteners 88 can include any suitable fasteners, such as, for example, bolts and nuts, screws, rivets etc. In some embodiments, each leg 86 of the worktable 26 of the CNC machine 14 can be bonded to a respective mechanical isolator 80, and each mechanical isolator 80 can be bonded (e.g., welded) to the floor 82 of the first container 20.

The following description of variants is only illustrative of components, elements, acts, products, and methods considered to be within the scope of the invention and are not in any way intended to limit such scope by what is specifically disclosed or not expressly set forth. The components, elements, acts, products, and methods as described herein may be combined and rearranged other than as expressly described herein and are still considered to be within the scope of the invention.

According to variation 1, a mobile CNC system may include a motor vehicle that comprises a first container defining an enclosed compartment; a CNC machine mounted on the motor vehicle and positioned inside the enclosed compartment; a battery that is constructed and arranged to provide power to at least the CNC machine; and a power inverter that is in electrical communication with the battery and the CNC machine, wherein the power inverter is constructed and arranged to convert a direct current (DC) from the battery to an alternating current (AC), and wherein the power inverter is further constructed and arranged to provide at least the CNC machine with the AC current.

According to variation 2, a mobile CNC system may include a motor vehicle that comprises a first container defining an enclosed compartment; a CNC machine mounted on the motor vehicle and positioned inside the enclosed compartment; a battery that is constructed and arranged to provide power to at least the CNC machine; and a power inverter that is in electrical communication with the battery and the CNC machine.

According to variation 3, a mobile CNC system may include a motor vehicle that comprises a first container defining an enclosed compartment; an engine; and an alternator that is in mechanical communication with the engine; a CNC machine mounted on the motor vehicle and positioned inside the enclosed compartment; a battery that is constructed and arranged to provide power to at least the CNC machine; and a power inverter that is in electrical communication with the battery and the CNC machine; wherein the alternator is in electrical communication with the battery.

Variation 4 may include a mobile CNC system as in variation 1, 2, or 3, wherein the CNC machine is a CNC router.

Variation 5 may include a mobile CNC system as in variation 1, 2, or 3, further comprising a dust collector constructed and arranged to remove dust and debris from the CNC machine.

Variation 6 may include a mobile CNC system as in variation 1, 2, or 3, wherein the CNC machine is constructed and arranged to cut plastics, elastomers, thermoplastic elastomers, or a combination thereof.

Variation 7 may include a mobile CNC system as in variation 1, 2, or 3, wherein the first container includes a door that is constructed and arranged to fluidly seal the enclosed compartment.

Variation 8 may include a mobile CNC system as in variation 1, 2, or 3, further comprising one or more mechanical isolators mounted on the motor vehicle, wherein the CNC machine is mounted on the one or more mechanical isolators.

Variation 9 may include a mobile CNC system as in variation 8, wherein the one or more mechanical isolators are made primarily of one or more elastomers.

Variation 10 may include a mobile CNC system as in variation 1, 2, or 3, wherein the CNC machine is constructed and arranged to cut ethylene vinyl acetate (EVA), polyethylene (PE) closed cell foam, or a combination thereof.

Variation 11 may include a mobile CNC system as in variation 1, 2, or 3, wherein the CNC machine is constructed and arranged to cut ethylene propylene diene monomer (EPDM), neoprene, chloroprene rubber (CR), styrene butadiene rubber (SBR), polyvinyl chloride (PVC), nitrile rubber (NRB), or any combination thereof.

Variation 12 may include a mobile CNC system as in variation 1, 2, or 3, wherein the first container of the motor vehicle includes a roof positioned over at least the CNC machine.

Many different embodiments have been disclosed herein, in connection with the above description and the drawings. It will be understood that it would be unduly repetitious and obfuscating to describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

An equivalent substitution of two or more elements can be made for anyone of the elements in the claims below or that a single element can be substituted for two or more elements in a claim. Although elements can be described above as acting in certain combinations, and even initially claimed as such, it is to be expressly understood that one or more elements from a claimed combination can, in some cases, be excised from the combination and that the claimed combination can be directed to a subcombination or variation of a subcombination.

It will be appreciated by persons skilled in the art that the present embodiment is not limited to what has been particularly shown and described herein above. A variety of modifications and variations are possible considering the above teachings without departing from the following claims.

I claim:

1. A mobile computer numerical control (CNC) system, comprising:
a motor vehicle that includes:
a first container defining an enclosed compartment;
a CNC machine mounted on the motor vehicle and positioned inside the enclosed compartment;
a battery that is constructed and arranged to provide power to at least the CNC machine;
and
a power inverter that is in electrical communication with the battery and the CNC machine, wherein the power inverter is constructed and arranged to convert a direct current (DC) from the battery to an alternating current (AC), and wherein the power inverter is further constructed and arranged to provide at least the CNC machine with the AC current.

2. The mobile CNC system of claim 1, wherein the CNC machine is a CNC router.

3. The mobile CNC system of claim 1, further comprising:
a dust collector constructed and arranged to remove dust and debris from the CNC machine.

4. The mobile CNC system of claim 1, wherein the CNC machine is constructed and arranged to cut plastics, elastomers, thermoplastic elastomers, or a combination thereof.

5. The mobile CNC system of claim 1, wherein the first container includes a door that is constructed and arranged to fluidly seal the enclosed compartment.

6. The mobile CNC system of claim 1, further comprising one or more mechanical isolators mounted on the motor vehicle, wherein the CNC machine is mounted on the one or more mechanical isolators.

7. The mobile CNC system of claim 6, wherein the one or more mechanical isolators are made primarily of one or more elastomers.

8. The mobile CNC system of claim 1, wherein the CNC machine is constructed and arranged to cut ethylene vinyl acetate (EVA), polyethylene (PE) closed cell foam, or a combination thereof.

9. The mobile CNC system of claim 1, wherein the CNC machine is constructed and arranged to cut ethylene propylene diene monomer (EPDM), neoprene, chloroprene rubber (CR), styrene butadiene rubber (SBR), polyvinyl chloride (PVC), nitrile rubber (NRB), or any combination thereof.

10. The mobile CNC system of claim 1, wherein the first container of the motor vehicle includes a roof positioned over at least the CNC machine.

11. A mobile computer numerical control (CNC) system, comprising:
a motor vehicle that includes:
a first container defining an enclosed compartment;
a CNC machine mounted on the motor vehicle and positioned inside the enclosed compartment;
a battery that is constructed and arranged to provide power to at least the CNC machine;
and
a power inverter that is in electrical communication with the battery and the CNC machine.

12. The mobile CNC system of claim 11, wherein the CNC machine is a CNC router.

13. The mobile CNC system of claim 11, further comprising:
a dust collector constructed and arranged to remove dust and debris from the CNC machine.

14. The mobile CNC system of claim 11, wherein the CNC machine is constructed and arranged to cut plastics, elastomers, thermoplastic elastomers, or a combination thereof.

15. The mobile CNC system of claim 11, wherein the first container includes a door that is constructed and arranged to fluidly seal the enclosed compartment.

16. The mobile CNC system of claim 11, further comprising one or more mechanical isolators mounted on the motor vehicle, wherein the CNC machine is mounted on the one or more mechanical isolators.

17. The mobile CNC system of claim 16, wherein the one or more mechanical isolators are made primarily of one or more elastomers.

18. The mobile CNC system of claim 11, wherein the CNC machine is constructed and arranged to cut ethylene vinyl acetate (EVA), polyethylene (PE) closed cell foam, or a combination thereof.

19. The mobile CNC system of claim 11, wherein the first container of the motor vehicle includes a roof positioned over at least the CNC machine.

20. A mobile computer numerical control (CNC) system, comprising:
a motor vehicle that includes:
a first container defining an enclosed compartment;
an engine; and
an alternator that is in mechanical communication with the engine;
a CNC machine mounted on the motor vehicle and positioned inside the enclosed compartment;
a battery that is constructed and arranged to provide power to at least the CNC machine;
and
a power inverter that is in electrical communication with the battery and the CNC machine;
wherein the alternator is in electrical communication with the battery.
